(19) United States
(12) Patent Application Publication
(10) Pub. No.: US 2026/0170609 A1
(43) Pub. Date: Jun. 18, 2026

(54) METHOD AND DEVICE FOR ACQUIRING IMAGES AND NON-TRANSIENT COMPUTER STORAGE MEDIUM

(71) Applicant: BOE Technology Group Co., Ltd., Beijing (CN)

(72) Inventors: Mengdi SUN, Beijing (CN); Dan ZHU, Beijing (CN)

(21) Appl. No.: 18/707,799

(22) PCT Filed: May 19, 2023
(86) PCT No.: PCT/CN2023/095199

§ 371 Date: May 6, 2024

(30) Foreign Application Priority Data
Jun. 22, 2022 (CN) 202210713170.9

(51) Int. Cl. G06T 5/50; G06T 3/4046; G06T 5/90

(52) U.S. Cl. CPC G06T 5/50; G06T 3/4046; G06T 5/90; G06T 2207/10144; G06T 2207/20081; G06T 2207/20084; G06T 2207/20208; G06T 2207/20221

(57) ABSTRACT

A method for acquiring images is provided. The method includes: acquiring a plurality of original images by shooting a same scene, wherein exposures of the plurality of original images are different; acquiring a first fused feature map by fusing the plurality of original images through a fusion network, wherein the fusion network comprises a first attention network; acquiring an adjusted feature map based on the first fused feature map and the plurality of original images; and acquiring a high dynamic range image corresponding to the plurality of original images based on the adjusted feature map.

### CROSS-REFERENCE TO RELATED APPLICATIONS

This application is a U.S. national phase application based on PCT/CN2023/095199, filed on May 19, 2023, which claims priority to Chinese Patent Application No. 202210713170.9, entitled “METHOD, APPARATUS, AND DEVICE FOR ACQUIRING IMAGES AND NON-TRANSITORY COMPUTER STORAGE MEDIUM”, filed on Jun. 22, 2022, the disclosure of which is herein incorporated by reference in its entirety.

### TECHNICAL FIELD

The present disclosure relates to the field of image technologies, and in particular, relates to a method and a device for acquiring images and a non-transitory computer storage medium.

### BACKGROUND

High dynamic range imaging (HDR) is a technology for implementing a larger dynamic range of exposure (that is, a larger difference between light and dark) than a conventional digital image technology. A high dynamic range image formed through high dynamic range imaging may provide a wider dynamic range and more image details.

### SUMMARY

Embodiments of the present disclosure provide a method and a device for acquiring images and a non-transitory computer storage medium. The technical solutions are as follows.

According to an aspect of the present disclosure, a method for acquiring images is provided. The method includes:
acquiring a plurality of original images by shooting the same scene, wherein exposures of the plurality of original images are different;
acquiring a first fused feature map by fusing the plurality of original images through a fusion network, wherein the fusion network includes a first attention network;
acquiring an adjusted feature map based on the first fused feature map and the plurality of original images; and
acquiring a high dynamic range image corresponding to the plurality of original images based on the adjusted feature map.

Optionally, the fusion network includes a first fusion subnetwork and a second fusion subnetwork, each of the first fusion subnetwork and the second fusion subnetwork including a first attention network; and
acquiring the first fused feature map by fusing the plurality of original images through the fusion network includes:
determining one original image of the plurality of original images as a reference image;
acquiring a reference feature map by performing feature extraction on the reference image;
acquiring a plurality of original feature maps by performing feature extraction on a plurality of original images other than the reference image in the plurality of original images respectively;
acquiring a second fused feature map corresponding to each original feature map by fusing the reference feature map respectively with the plurality of original feature maps through the first fusion subnetwork; and
fusing the plurality of second fused feature maps through the second fusion subnetwork to acquire the first fused feature map.

Optionally, acquiring a second fused feature map corresponding to each original feature map by fusing the reference feature map respectively with the plurality of original feature maps through the first fusion subnetwork includes:
acquiring a first reference feature map by downsampling the reference feature map;
acquiring a first original feature map by downsampling the original feature map;
acquiring a first attention feature map by merging the first reference feature map and the first original feature map, and inputting the merged feature map into the first attention network; and
upsampling the first attention feature map to acquire the second fused feature map.

Optionally, acquiring the adjusted feature map based on the first fused feature map and the plurality of original images includes:
determining one original image of the plurality of original images as a reference image;
acquiring a plurality of original feature maps by performing feature extraction on a plurality of original images other than the reference image in the plurality of original images respectively;
acquiring a second attention feature map by inputting the first fused feature map into a second attention network; and
acquiring a plurality of adjusted feature maps corresponding to the plurality of original feature maps by inputting the second attention feature map into a plurality of spatial feature transform networks respectively, and inputting the plurality of original feature maps into the plurality of spatial feature transform networks respectively,
wherein the spatial feature transform network is configured to determine a spatial parameter matrix based on the original feature map, and spatially transform the second attention feature map by using the spatial parameter matrix, wherein the spatial parameter matrix is acquired by performing convolution processing on the original feature map.

Optionally, acquiring the high dynamic range image corresponding to the plurality of original images based on the adjusted feature map includes:
acquiring the plurality of adjusted feature maps corresponding to the plurality of original feature maps;
acquiring a merged feature map by merging the plurality of adjusted feature maps;
acquiring an important feature map by inputting the merged feature map into a third attention network; and
dimensionally reducing the important feature map through at least one convolution layer to acquire the high dynamic range image.

Optionally, determining one original image of the plurality of original images as the reference image includes:
sorting the plurality of original images in descending order of exposure; and
selecting an original image with a centered exposure as the reference image.

Optionally, acquiring the reference feature map by performing feature extraction on the reference image includes:
inputting the reference image into a densely connected residual network to acquire the reference feature map.

Optionally, before acquiring the plurality of original images by shooting the same scene, the method further includes:
acquiring training samples from a sample set, wherein the sample set includes a plurality of training samples, the training samples including a plurality of sample images acquired by shooting the same scene and a target sample high dynamic range image corresponding to the plurality of sample images, and exposures of the plurality of sample images are different;
acquiring a first fused feature map by fusing the plurality of sample images through a to-be-trained fusion network, wherein the fusion network includes a to-be-trained first attention network;
acquiring an adjusted feature map based on the first fused feature map and the plurality of sample images;
acquiring a high dynamic range image corresponding to the plurality of sample images based on the adjusted feature map;
acquiring a comparison difference by comparing the high dynamic range image corresponding to the plurality of sample images with the target sample high dynamic range image;
adjusting, in the case that the comparison difference is greater than a predetermined result, the to-be-trained fusion network based on the comparison difference and performing the step of acquiring the training samples from the sample set; and
determining, in the case that the comparison difference is less than or equal to the predetermined result, the to-be-trained fusion network as the fusion network.

Optionally, the densely connected residual network includes three 3×3 convolution layers and three activation layers.

Optionally, the first attention network includes four 3×3 convolution layers, one 1×1 convolution layer, one 3×3 strided convolution layer, two 3×3 dilated convolution layers, one 3×3 depthwise convolution layer, and two activation layers.

Optionally, a quantity of the original feature maps is equal to a quantity of the spatial feature transform networks.

Optionally, the quantity of the original feature maps and the quantity of the spatial feature transform networks are both greater than or equal to 2.

Optionally, acquiring the merged feature map by merging the plurality of adjusted feature maps includes:

merging the plurality of adjusted feature maps through a connection function to acquire the merged feature map.

Optionally, a quantity of the plurality of original images is greater than or equal to 3.

According to another aspect of the present disclosure, a device for acquiring images is provided. The device for acquiring images includes a processor and a memory storing at least one instruction, at least one program, a code set, or an instruction set, wherein the processor, when loading and executing the at least one instruction, the at least one program, the code set, or the instruction set, is caused to perform the foregoing method for acquiring images.

According to another aspect of the present disclosure, a non-transitory computer storage medium is provided. The non-transitory computer storage medium stores at least one instruction, at least one program, a code set, or an instruction set, wherein the at least one instruction, the at least one program, the code set, or the instruction, when loaded and executed by a processor, causes the processor to perform the foregoing method for acquiring images.

According to another aspect of the present disclosure, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, such that the computer device is caused to perform the foregoing method for acquiring images.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for acquiring images according to some embodiments of the present disclosure;

FIG. 2 is a flowchart of another method for acquiring images according to some embodiments of the present disclosure;

FIG. 3 is a schematic structural diagram of a densely connected residual network according to some embodiments of the present disclosure;

FIG. 4 is a schematic structural diagram of a first fusion subnetwork according to some embodiments of the present disclosure;

FIG. 5 is a flowchart of acquiring a second fused feature map according to some embodiments of the present disclosure;

FIG. 6 is a schematic structural diagram of a first attention network according to some embodiments of the present disclosure;

FIG. 7 is a schematic structural diagram of a spatial transform network according to some embodiments of the present disclosure;

FIG. 8 is a flowchart of acquiring a high dynamic range image according to some embodiments of the present disclosure;

FIG. 9 is a flowchart of training a fusion network according to some embodiments of the present disclosure;

FIG. 10 is a diagram of a network architecture according to some embodiments of the present disclosure; and

FIG. 11 is a structural block diagram of an apparatus for acquiring images according to some embodiments of the present disclosure.

Specific embodiments of the present disclosure are shown in the accompanying drawings above, and are further described in detail below. These accompanying drawings and text descriptions are not used to limit the scope of the concept of the present disclosure in any manner. Instead, the concept of the present disclosure is described for a person skilled in the art with reference to specific embodiments.

### DETAILED DESCRIPTION

For clearer descriptions of the objectives, technical solutions, and advantages of the present disclosure, embodiments of the present disclosure are described in detail hereinafter with reference to the accompanying drawings.

An application scenario in embodiments of the present disclosure is described first.

With the development of image technologies, the problem of low image dynamic ranges is attracting increasing attention accordingly. A dynamic range is a range of brightness that a device can capture or display, that is, a range from the darkest black to the brightness white. To resolve the foregoing problem, the high dynamic range imaging technology has been developing rapidly. For example, some scenes that need to be shot, such as landscape shooting, nightscape shooting, and indoor shooting, include large dynamic ranges. These scenes are usually relatively stable and have large differences between light and dark. As a result, a photography device cannot completely shoot all details in such scenes through shooting once. A process of acquiring a high dynamic range image may include: First, the same scene is shot based on different exposures to acquire a plurality of images. A part of an entire dynamic range of the scene can be acquired in each image. The plurality of images may all be referred to as low dynamic range images, and then the plurality of low dynamic range images are synthesized into one high dynamic range image. Compared with a low dynamic range image, the high dynamic range image may provide a wider dynamic range and more image details, and can better reflect a visual effect in an actual environment.

It needs to be noted that the application scenario described in the embodiments of the present disclosure is used for describing the technical solutions in the embodiments of the present disclosure more clearly, and does not constitute a limitation to the technical solutions provided in the embodiments of the present disclosure. A person of ordinary skill in the art may know that the technical solutions provided in the embodiments of the present disclosure are also applicable to similar technical problems.

The implementation environment may include a shooting scene, a shooting assembly, a server, and a display terminal. The shooting scene may include a plant, a landscape, and the like. The shooting assembly may include a camera. The server includes a processor. The server may establish a wired or wireless connection with the shooting assembly, to generate a high dynamic range image based on images captured by the shooting assembly, and display the high dynamic range image on the display terminal.

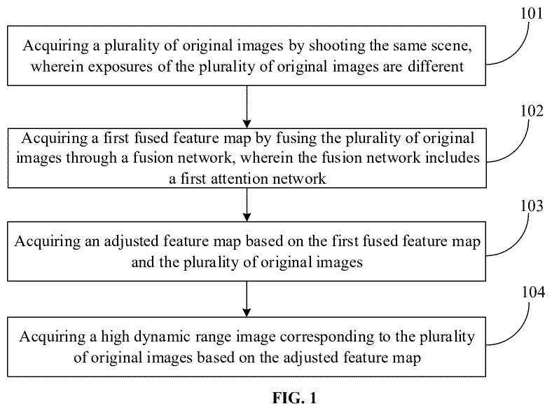

FIG. 1 is a flowchart of a method for acquiring images according to some embodiments of the present disclosure. The method may be applied to the server in the foregoing implementation environment. The method may include the following steps:

In step 101, a plurality of original images are acquired by shooting the same scene, wherein exposures of the plurality of original images are different.

In step 102, a first fused feature map is acquired by fusing the plurality of original images are fused through a fusion network, wherein the fusion network includes a first attention network.

In step 103, an adjusted feature map is acquired based on the first fused feature map and the plurality of original images.

In step 104, a high dynamic range image corresponding to the plurality of original images is acquired based on the adjusted feature map.

In summary, the embodiments of the present disclosure provide a method for acquiring images. A plurality of original images with different exposures acquired by shooting the same scene are fused to acquire a high dynamic range image corresponding to the plurality of original images. A fusion process of the plurality of original images is introduced into the first attention network, and importance of different image features is estimated by using the first attention network, to highlight image features that are beneficial to acquiring the high dynamic range image, and inhibit interfering features caused by movement. In this way, the impact on image fusion caused by movement in a process of shooting the plurality of original images can be mitigated, and the problem in the related art that an acquired high dynamic range image has poor definition can be resolved, thereby improving the definition of an acquired high dynamic range image.

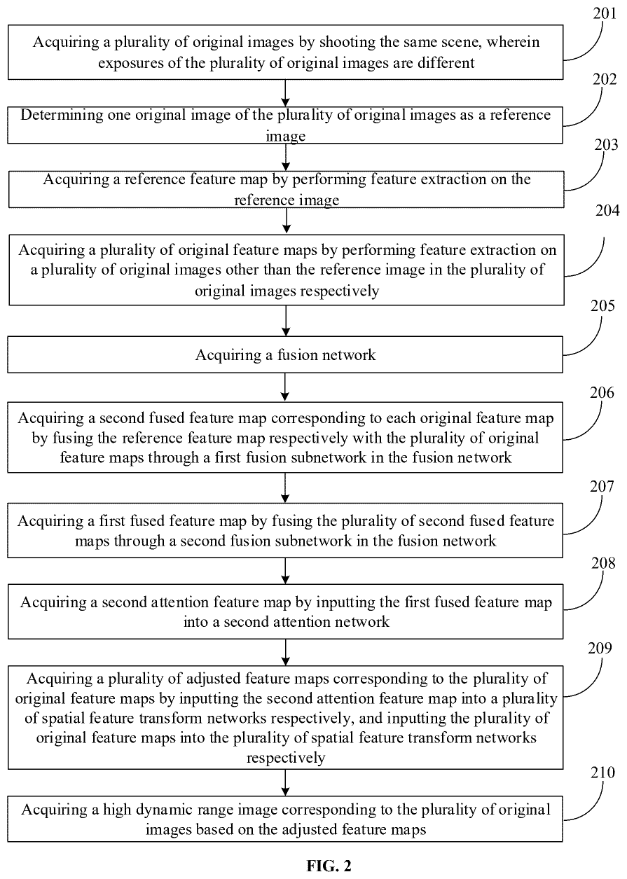

FIG. 2 is a flowchart of another method for acquiring images according to some embodiments of the present disclosure. The method may be applied to the server in the foregoing implementation environment. The method may include the following steps:

In step 201, a plurality of original images are acquired by shooting the same scene, wherein exposures of the plurality of original images are different.

The same scene may be consecutively shot to acquire the plurality of original images with different exposures. For example, the same scene may be shot with a camera by rapidly adjusting exposures within a short time to acquire the plurality of original images with different exposures. For example, an HDR mode may be selected in the camera to consecutively shoot the same scene three times, to acquire an original image with a low exposure, an original image with a medium exposure, and an original image with a high exposure. The brightness of an original image with a larger exposure is higher, and the brightness of an original image with a lower exposure is lower.

Optionally, a quantity of the plurality of original images in the embodiments of the present disclosure may be N, wherein N is an integer greater than or equal to 3.

In step 202, one original image of the plurality of original images is determined as a reference image.

An original image with a centered exposure in the plurality of original images may be used as the reference image. The reference image has a balanced exposure and has rich image details. Parts with good exposures are acquired from a plurality of original images with a low exposure (underexposed compared with the reference image) and a high exposure (overexposed compared with the reference image) and are fused with the reference image, such that an acquired high dynamic range image can record related image details in both bright highlights and dark shadows, making the high dynamic range image closer to an actual scene seen by human eyes.

Optionally, the plurality of original images may be first sorted in descending order of exposure. The plurality of original images may all be low dynamic range images. For example, three original images are sorted in descending order of exposure as a first original image, a second original image, and a third original image.

Subsequently, an original image with a centered exposure is selected from the sorted plurality of original images as the reference image. For example, the second original image is selected as the reference image.

In step 203, a reference feature map is acquired by performing feature extraction on the reference image.

Feature extraction may be performed on the reference image through a feature extraction network. For example, feature extraction may be performed on the reference image through convolution processing, to convert the reference image into the reference feature map. The feature extraction network in the embodiments of the present disclosure may be a densely connected residual network (Residual Dense Block, RDB). In a process of extracting the reference feature map, the reference image may be inputted into the densely connected residual network to output the reference feature map.

As shown in FIG. 3, FIG. 3 is a schematic structural diagram of a densely connected residual network according to some embodiments of the present disclosure. Conv denotes a convolution layer. C denotes a concatenation function (Concat). Concat is used to denote a merging or permutation operation of matrices. R denotes a Relu activation function. The Relu activation function is a rectifier linear function. When an input is less than 0, an output is 0. When an input is greater than 0, an output is the inputted value. This activation function can make the network converge faster, such that mutual dependence between parameters can be mitigated. F_{d-1} denotes an input of a d′ densely connected residual network, F_{d} denotes an output of the d^{th} densely connected residual network, F_{d,1} denotes an output of the first convolution layer in the d^{th} densely connected residual network, F_{d,c} denotes an output of a c^{th} convolution layer in the d^{th} densely connected residual network, and F_{d,LF} denotes local feature fusion.

An input of a densely connected residual network is a reference image, an output of the densely connected residual network is a reference feature map, and the reference feature map may be one matrix. The densely connected residual network shown in FIG. 3 may include three 3×3 convolution layers and three activation layers (Relu). It may be understood that the densely connected residual network may be considered as a combination of a residual network structure and a dense network structure. The densely connected residual network has a plurality of convolution layers. Therefore, the introduction of the residual network structure can further improve information flows between a plurality of convolution layers, thereby reducing the difficulty of training the densely connected residual network. The dense network structure can effectively alleviate the vanishing gradient problem, and may enhance feature propagation and promote feature reuse, thereby improving the utilization of parameters in the densely connected residual network and reducing an unnecessary calculation amount.

In step 204, a plurality of original feature maps are acquired by performing feature extraction on a plurality of original images other than the reference image in the plurality of original images respectively.

In a process of extracting the reference feature map, the plurality of original images other than the reference image may be respectively inputted into the densely connected residual network to output the plurality of original feature maps. The structure of the densely connected residual network is the same as that of the densely connected residual network in step 203. In addition, a quantity of the densely connected residual networks in this embodiment is determined based on the quantity of the original images. That is, the quantity of the densely connected residual network is the same as the quantity of the plurality of original images. For example, three densely connected residual networks may be provided in the embodiments of the present disclosure.

Because the exposures of the plurality of original images are different, the same scene has different information such as brightness, contrast, texture, contour, and the like in the original images with different exposures. In the case that feature extraction is performed on the plurality of original images through the same densely connected residual network, generated shared parameters damage inherent features of the scene at different exposures. Therefore, a multi-channel architecture may be used in the process of feature extraction. The plurality of densely connected residual networks do not share any learning parameter, and the plurality of densely connected residual networks may perform feature extraction on the plurality of original images simultaneously. That is, step 203 and step 204 may be performed simultaneously.

In step 205, a fusion network is acquired.

The fusion network may be a trained fusion network. The fusion network may include a plurality of convolution layers and a first attention network. The first attention network may be a first attention network acquired through training.

In step 206, a second fused feature map corresponding to each original feature map is acquired by fusing the reference feature map respectively with the plurality of original feature maps through a first fusion subnetwork in the fusion network.

Optionally, in the embodiments of the present disclosure, the fusion network may include a first fusion subnetwork and a second fusion subnetwork, and each of the first fusion subnetwork and the second fusion subnetwork may include a first attention network. The first fusion subnetwork and the second fusion subnetwork in the fusion network may have the same structure, and may both be referred to as spatial-adaptive networks (Spatial Attention Module, SAM). The plurality of fusion subnetworks do not share any learning parameter.

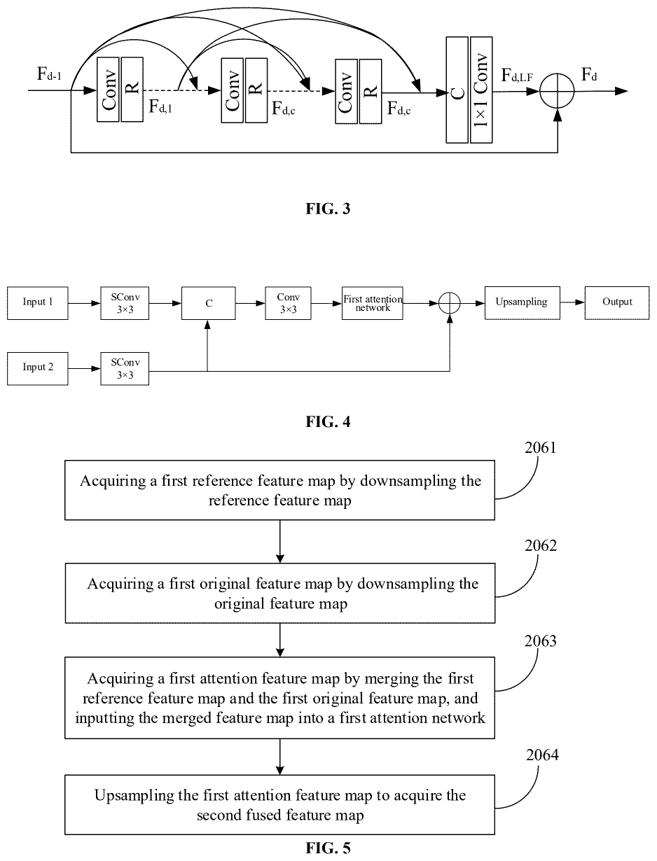

As shown in FIG. 4, FIG. 4 is a schematic structural diagram of a first fusion subnetwork according to some embodiments of the present disclosure. An input of the first fusion subnetwork is a reference feature map and one original feature map of a plurality of original feature maps, and an output of the first fusion subnetwork is a second fused feature map. Conv denotes a convolution layer, C denotes a merging or permutation operation of matrices, and SConv denotes strided convolution. A step size of the strided convolution herein is 2. That is, each of the reference feature map and the original feature map is reduced twice after the strided convolution. Therefore, in a subsequent image processing process, the reference feature map and the original feature map may be restored through upsampling.

In a process of image fusion, the plurality of inputted original images have different exposures and are not completely aligned. Therefore, the reference feature map and the original feature map are directly merged together, and merged features are inputted into a subsequent convolution layer. As a result, there may be a misalignment problem between the merged features. Therefore, in the embodiments of the present disclosure, the first attention network is introduced into the process of image fusion, to highlight important image features that are beneficial to fusion and inhibit image features in misaligned, ghosting, undersaturated, oversaturated, and other low quality regions.

As shown in FIG. 5, step 206 may include the following four substeps:

In substep 2061, a first reference feature map is acquired by downsampling the reference feature map is downsampled.

The reference feature map is downsampled, such that the dimensionality of the reference feature map can be reduced, and effective information can be kept, to avoid an overfitting problem.

In substep 2062, a first original feature map is acquired by downsampling the original feature map.

Similarly, the original feature map is downsampled, such that the dimensionality of the reference feature map can be reduced, effective information can be kept, and an overfitting problem can be avoided. Step 2051 and step 2052 may be performed simultaneously, thereby improving the efficiency of image fusion.

In substep 2063, a first attention feature map is acquired by merging the first reference feature map and the first original feature map, and inputting the merged feature map into the first attention network.

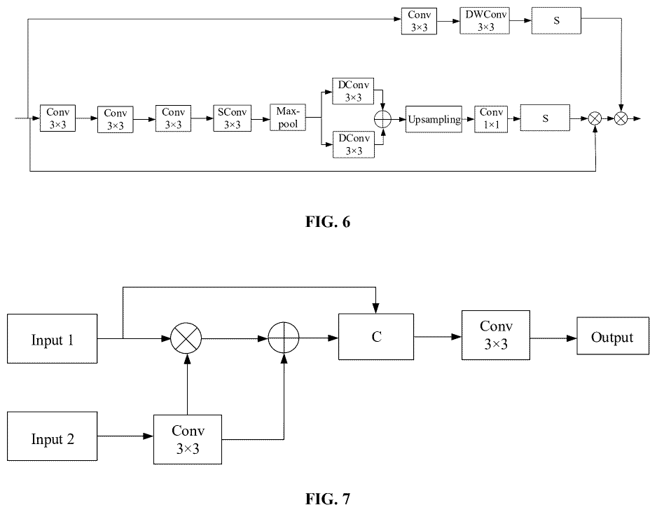

As shown in FIG. 6, FIG. 6 is a schematic structural diagram of a first attention network according to some embodiments of the present disclosure. Conv denotes a convolution layer, SConv denotes strided convolution, Max-Pool denotes maximum pooling, Concat denotes a merging or permutation operation of matrices, DConv denotes dilated convolution, DWConv denotes depthwise convolution, and S denotes a Sigmoid activation function. The Sigmoid activation function is a logical activation function, and is also referred to as an S-shaped growth curve. The Sigmoid function may be used as an activation function of a neural network, to map a variable into [0, 1]. The dilated convolution may extend the receptive field, which is helpful in restoring missing of image details caused by oversaturated regions and movement misalignment.

It needs to be noted that, the structure of the first attention network in the embodiments of the present disclosure may be the first attention network shown in FIG. 6, or may be an attention network with another structure, which is not limited in the embodiments of the present disclosure.

It needs to be noted that, each of the reference feature map and the original feature map in the embodiments of the present disclosure is essentially one matrix. In the embodiment shown in FIG. 4, the merging of the first reference feature map and the first original feature map is essentially the merging of two matrices, and is a process of permutating or merging the two matrices without changing the orders in the two matrices.

In substep 2064, the first attention feature map is upsampled to acquire the second fused feature map.

The upsampling may be configured to enlarge an image, and the second fused feature map may be a feature map with a weight value.

In step 207, a first fused feature map is acquired by fusing the plurality of second fused feature maps through a second fusion subnetwork in the fusion network.

The first fusion subnetwork is similar to the feature extraction network. A multi-channel design with the same structure may be used for the first fusion subnetwork. That is, the plurality of original feature maps may be first fused with the reference feature map respectively the first time to acquire the plurality of second fused feature maps, and subsequently the plurality of second fused feature maps are then fused the second time. An input of the second fusion subnetwork is the plurality of second fused feature maps, and an output of the second fusion subnetwork is the first fused feature map.

In step 208, a second attention feature map is acquired by inputting the first fused feature map into a second attention network.

The structure of the second attention network may be the same as that of the first attention network shown in FIG. 6. The first fused feature map may be processed by using the second attention network, to keep important image information in the first fused feature map and highlight image features that are beneficial to fusion.

In step 209, a plurality of adjusted feature maps corresponding to the plurality of original feature maps are acquired by inputting the second attention feature map into a plurality of spatial feature transform networks respectively, and inputting the plurality of original feature maps into the plurality of spatial feature transform networks respectively.

The the spatial feature transform network is configured to determine a spatial parameter matrix based on the original feature map, and spatially transform the second attention feature map by using the spatial parameter matrix, wherein the spatial parameter matrix is acquired by performing convolution processing on the original feature map.

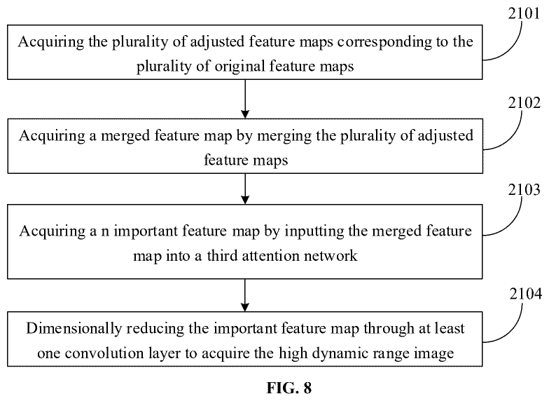

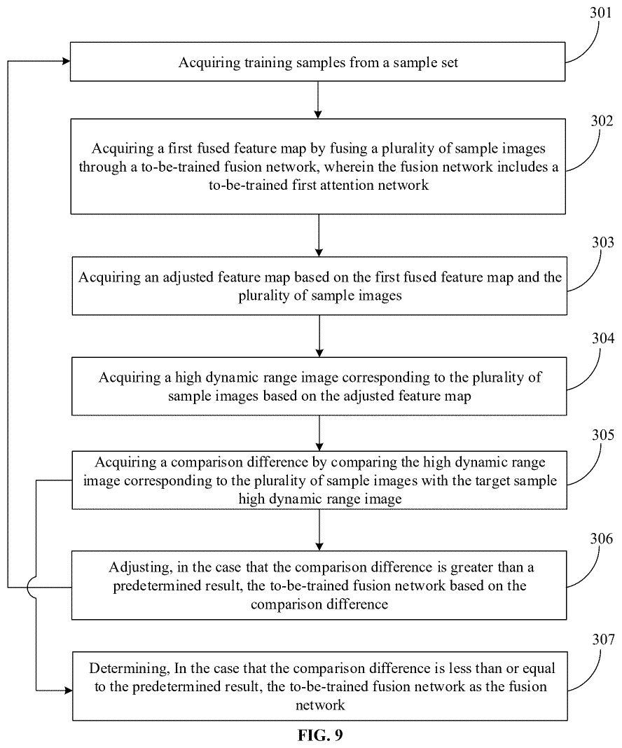

As shown in FIG. 7, FIG. 7 is a schematic structural diagram of a spatial transform network according to some embodiments of the present disclosure. Conv denotes a convolution layer. C denotes a merging or permutation operation of matrices. The spatial feature transform network is similar to the feature extraction network. A multi-channel design with the same structure may also be used for the spatial feature transform network. That is, the plurality of original feature maps are used to perform spatial transform on the second attention feature map respectively, to respectively acquire the plurality of adjusted feature maps corresponding to the plurality of original feature maps.

For example, a quantity of the original feature maps may be equal to a quantity of the spatial feature transform networks, and the quantity of the original feature maps and the quantity of the spatial feature transform networks may be both greater than or equal to 2.

The spatial feature transform network can modulate the second attention feature map through the spatial parameter matrix, such that the modulated second attention feature map has more features related to image texture, and local distortions and information losses of the second attention feature map can be corrected.

In step 210, a high dynamic range image corresponding to the plurality of original images is acquired based on the adjusted feature maps.

The plurality of original feature maps have different feature information. Therefore, the plurality of adjusted feature maps corresponding to the plurality of original images may be acquired, to acquire a high dynamic range image with more image details based on the plurality of adjusted feature maps.

As shown in FIG. 8, step 210 may include the following four substeps:

In substep 2101, the plurality of adjusted feature maps corresponding to the plurality of original feature maps are acquired.

The plurality of original feature maps have different feature information. Therefore, spatial transform may be respectively performed on the second attention feature map through a plurality of spatial parameter matrices generated from a plurality of original features, thereby improving the accuracy of spatial transform of images.

In substep 2102, a merged feature map is acquired by merging the plurality of adjusted feature maps.

The plurality of adjusted feature maps may be merged through a concatenation function (Concat), such that the merged feature map has more image details.

In substep 2103, an important feature map is acquired by inputting the merged feature map into a third attention network.

The structure of the third attention network may be the same as that of the first attention network shown in FIG. 6. The importance of different image features in the merged feature map may be estimated again through the third attention network, to highlight image features that are beneficial to acquiring the high dynamic range image, and inhibit interfering features caused by movement. In this way, the impact on image fusion caused by movement in a process of shooting the plurality of original images can be mitigated, thereby improving the definition of an acquired high dynamic range image.

In substep 2104, the important feature map is dimensionally reduced through at least one convolution layer to acquire the high dynamic range image.

Redundant information may exist in the foregoing the important feature map. The important feature map may be dimensionally reduced by using a combination of two 3×3 convolution layers and an activation function to acquire the high dynamic range image.

In summary, the embodiments of the present disclosure provide a method for acquiring images. A plurality of original images with different exposures acquired by shooting the same scene are fused to acquire a high dynamic range image corresponding to the plurality of original images. A fusion process of the plurality of original images is introduced into the first attention network, and importance of different image features is estimated by using the first attention network, to highlight image features that are beneficial to acquiring the high dynamic range image, and inhibit interfering features caused by movement. In this way, the impact on image fusion caused by movement in a process of shooting the plurality of original images can be mitigated, and the problem in the related art that an acquired high dynamic range image has poor definition can be resolved, thereby improving the definition of an acquired high dynamic range image.

Optionally, the fusion network in step 205 may be a fusion network trained in advance, or the fusion network may be trained in step 205. It needs to be noted that, the networks (the fusion network, the first attention network, the second attention network, the third attention network, and the feature transform network) used in the embodiments of the present disclosure are all trained network structures, and the networks may be trained through depthwise learning. The depthwise learning is a method of machine learning. The training manner of these networks is not limited in the embodiments of the present disclosure.

In the training of the fusion network, a low dynamic range image may be used as an input, and a high dynamic range image corresponding to the low dynamic range image is used as a true value. In a training process, low dynamic range images may be randomly extracted from a sample library and inputted into the fusion network to perform training. An Adam optimizer may be used as a network optimizer. An initial learning rate is 1e−4. A loss function includes L1 losses and PSNR losses of the low dynamic range image and the high dynamic range image. A formula of the loss function is as follows:

$$Loss = {‖ \hat{I} - {I}_{gt} ‖}_{1} + 10 * {‖ \frac{log ( 1 + 50 \; 00 * \hat{I} )}{5001} - \frac{log ( 1 + 5000 * {I}_{gt} )}{5001} ‖}_{1}$$

An L1 loss is also referred to as a minimum absolute deviation, and a total sum of absolute differences between actual values and a target value is calculated. PSNR is a peak signal-to-noise ratio, and is used for measuring a difference between two images. Î denotes a true value, and I_{gt} denotes a test value in the training process.

As shown in FIG. 9, in the embodiments of the present disclosure, the training process of the fusion network may include the following steps:

In step 301, training samples are acquired from a sample set.

The sample set includes a plurality of training samples, the training samples include a plurality of sample images acquired by shooting the same scene and a target sample high dynamic range image corresponding to the plurality of sample images, and exposures of the plurality of sample images are different.

The target sample high dynamic range image is a high dynamic range image that is formed by fusing the plurality of training samples and has a high definition.

In step 302, a first fused feature map by fusing the plurality of sample images through a to-be-trained fusion network, wherein the fusion network includes a to-be-trained first attention network.

In step 302, a densely connected residual network for performing feature extraction on the plurality of samples images is included, and in the training process, the densely connected residual network may be trained synchronously with the fusion network.

In step 303, an adjusted feature map is acquired based on the first fused feature map and the plurality of sample images.

In step 303, a second attention network and a spatial feature transform network may be included. Similarly, the second attention network and the spatial feature transform network may be trained synchronously with the fusion network.

In step 304, a high dynamic range image corresponding to the plurality of sample images is acquired based on the adjusted feature map.

In step 304, a third attention network may be included. Similarly, the third attention network may be trained synchronously with the fusion network.

In step 305, a comparison difference is acquired by comparing the high dynamic range image corresponding to the plurality of sample images with the target sample high dynamic range image.

In step 306, in the case that the comparison difference is greater than a predetermined result, the to-be-trained fusion network is adjusted based on the comparison difference, and the step of acquiring the training samples from the sample set is performed.

In the case that the difference between the acquired high dynamic range image and the target sample high dynamic range image is large, it may indicate that parameters in the fusion network are not accurate enough, and the parameters in the fusion network may be further adjusted through a plurality of times of training. That is, step 301 is performed after step 306.

In step 307, in the case that the comparison difference is less than or equal to the predetermined result, the to-be-trained fusion network is determined as the fusion network.

In the case that the difference between the acquired high dynamic range image and the target sample high dynamic range image is small, it may indicate that parameters in the fusion network are accurate, and the training of the fusion network may be ended.

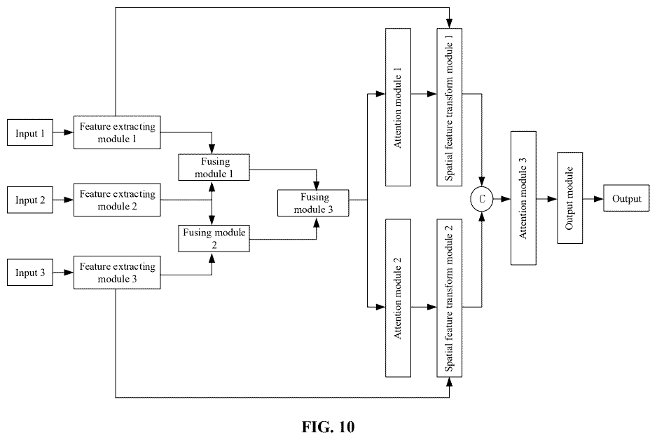

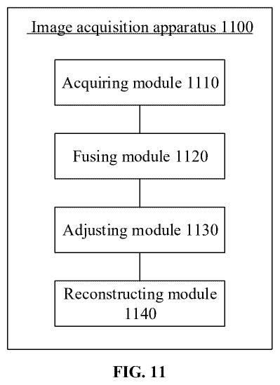

Optionally, as shown in FIG. 10, FIG. 10 is a diagram of a network architecture according to some embodiments of the present disclosure. A plurality of inputs (an input 1, an input 2, and an input 3) may be a plurality of original images with different exposures. The input 2 may be a reference image.

A plurality of feature extracting modules (a feature extracting module 1, a feature extracting module 2, and a feature extracting module 3) may be configured to perform feature extraction on the plurality of original images. For example, step 203 and step 204 in the embodiments shown in FIG. 2 may be performed.

A fusing module 1 and a fusing module 2 in a plurality of fusing modules may be configured to respectively fuse a plurality of original feature maps and a reference feature map the first time to acquire a plurality of second fused feature maps. For example, step 206 in the embodiments shown in FIG. 2 may be performed. A fusing module 3 in the plurality of fusing modules may be configured to fuse the plurality of second fused feature maps. For example, step 207 in the embodiments shown in FIG. 2 may be performed.

A plurality of spatial feature transform modules (a spatial feature transform module 1 and a spatial feature transform module 2) and a plurality of attention modules (an attention module 1 and an attention module 2) may be respectively configured to adjust a fused image feature based on an image feature of an original image. For example, step 208 and step 209 in the embodiments shown in FIG. 2 may be performed.

C denotes a merging or permutation operation of matrices.

An attention module 3 and an output module may be configured to acquire a high dynamic range image corresponding to the plurality of original images based on the adjusted feature map. For example, step 210 in the embodiments shown in FIG. 2 may be performed.

FIG. 11 is a structural block diagram of an apparatus for acquiring images according to some embodiments of the present disclosure. The apparatus for acquiring images 1100 includes:

an acquiring module 1110, configured to acquire a plurality of original images acquired by shooting the same scene, wherein exposures of the plurality of original images are different;

a fusing module 1120, configured to acquire a first fused feature map by fusing the plurality of original images through a fusion network, wherein the fusion network includes a first attention network;
an adjusting module 1130, configured to acquire an adjusted feature map based on the first fused feature map and the plurality of original images; and
a reconstructing module 1140, configured to acquire a high dynamic range image corresponding to the plurality of original images based on the adjusted feature map.

Optionally, the fusing module 1120 includes:
a first determining module, configured to determine one original image of the plurality of original images as a reference image;
a first feature extracting module, configured to acquire a reference feature map by performing feature extraction on the reference image;
a second feature extracting module, configured to acquire a plurality of original feature maps by performing feature extraction on a plurality of original images other than the reference image in the plurality of original images respectively;
a first fusing submodule, configured to acquire a second fused feature map corresponding to each original feature map by fusing the reference feature map respectively with the plurality of original feature maps through the first fusion subnetwork; and
a second fusing submodule, configured to fuse the plurality of second fused feature maps through a second fusion subnetwork to acquire the first fused feature map.

Optionally, the first fusing submodule is configured to:
acquire a first reference feature map by downsampling the reference feature map;
acquire a first original feature map by downsampling the original feature map;
acquire a first attention feature map by merging the first reference feature map and the first original feature map, and inputting the merged feature map into the first attention network; and
upsample the first attention feature map to acquire the second fused feature map.

Optionally, the adjusting module 1130 includes:
a first determining module, configured to determine one original image of the plurality of original images as a reference image;
a first extracting module, configured to acquire a plurality of original feature maps by performing feature extraction on a plurality of original images other than the reference image in the plurality of original images respectively;
a first attention module, configured to acquire a second attention feature map by inputting the first fused feature map into a second attention network; and
a first spatial module, configured to acquire a plurality of adjusted feature maps corresponding to the plurality of original feature maps by inputting the second attention feature map into a plurality of spatial feature transform networks respectively, and inputting the plurality of original feature maps into the plurality of spatial feature transform networks respectively.

The the spatial feature transform network is configured to determine a spatial parameter matrix based on the original feature map, and spatially transform the second attention feature map by using the spatial parameter matrix, wherein the spatial parameter matrix is acquired by performing convolution processing on the original feature map.

Optionally, the reconstructing module 1140 is configured to:
acquire the plurality of adjusted feature maps corresponding to the plurality of original feature maps;
acquire a merged feature map by merging the plurality of adjusted feature maps;
acquire an important feature map by inputting the merged feature map into a third attention network; and
dimensionally reduce the important feature map through at least one convolution layer to acquire the high dynamic range image.

In summary, the embodiments of the present disclosure provide an apparatus for acquiring images. A plurality of original images with different exposures acquired by shooting the same scene are fused to acquire a high dynamic range image corresponding to the plurality of original images. A fusion process of the plurality of original images is introduced into the first attention network, and importance of different image features is estimated by using the first attention network, to highlight image features that are beneficial to acquiring the high dynamic range image, and inhibit interfering features caused by movement. In this way, the impact on image fusion caused by movement in a process of shooting the plurality of original images can be mitigated, and the problem in the related art that an acquired high dynamic range image has poor definition can be resolved, thereby improving the definition of an acquired high dynamic range image.

In addition, the embodiments of the present disclosure further provide a schematic structural diagram of an electronic device. The electronic device includes one or more processors, a photographing assembly, a memory, and a terminal. The memory may include a random access memory (RAM) and a read-only memory (ROM). The photographing assembly and the terminal may be an integral structure. A part related to network training in the foregoing method for acquiring images may be applied to the server. Another part related to image processing other than network training may be applied to the server or may be applied to the terminal.

In addition, the embodiments of the present disclosure further provide a device for acquiring images. The device for acquiring images includes a processor and a memory storing at least one instruction, at least one program, a code set, or an instruction set, wherein the processor, when loading and executing the at least one instruction, the at least one program, the code set, or the instruction set, is caused to perform the method for acquiring images in any foregoing embodiment.

In addition, the embodiments of the present disclosure further provide a non-transitory computer storage medium, wherein the non-transitory computer storage medium stores at least one instruction, at least one program, a code set, or an instruction set, wherein the at least one instruction, the at least one program, the code set, or the instruction set, when loaded and executed by a processor, causes the processor to perform the method for acquiring images in any foregoing embodiment.

In addition, the embodiments of the present disclosure further provide a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, such that the computer device is caused to perform the method for acquiring images in any foregoing embodiment.

In the present disclosure, the terms “first”, “second”, and “third” are used only for description, but are not intended to indicate or imply relative importance. The term “a plurality of” means two or more than two, unless otherwise clearly specified.

In the several embodiments provided in the present disclosure, it should be understood that the disclosed apparatuses and methods may be implemented in other manners. For example, the foregoing apparatus embodiments are merely examples. For example, division of the units is merely a logical function division and may be another division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or another form.

The units described as separate parts may or may not be physically separate, and parts displayed as units may or may not be physical units, and may be located at one position, or may be distributed on a plurality of network units. Some or all of the units may be selected depending on actual requirements to achieve the objectives of the solutions in the embodiments.

A person of ordinary skill in the art may understand that all or a part of the steps of the embodiments may be implemented by hardware or a program instructing relevant hardware. The program may be stored in a computer-readable storage medium. The storage medium may be a read-only memory, a magnetic disk, an optical disc, or the like.

The foregoing is merely optional embodiments of the present disclosure but is not used to limit the present disclosure. Any changes, equivalent replacements, and improvements made within the spirit and principle of the present disclosure shall fall within the protection scope of the present disclosure.

1. A method for acquiring images, comprising:
acquiring a plurality of original images by shooting a same scene, wherein exposures of the plurality of original images are different;
acquiring a first fused feature map by fusing the plurality of original images through a fusion network, wherein the fusion network comprises a first attention network;
acquiring an adjusted feature map based on the first fused feature map and the plurality of original images; and
acquiring a high dynamic range image corresponding to the plurality of original images based on the adjusted feature map.

2. The method for acquiring images according to claim 1, wherein the fusion network comprises a first fusion subnetwork and a second fusion subnetwork, each of the first fusion subnetwork and the second fusion subnetwork comprising the first attention network; and
said acquiring the first fused feature map by fusing the plurality of original images through the fusion network comprises:
determining one original image of the plurality of original images as a reference image;
acquiring a reference feature map by performing feature extraction on the reference image;
acquiring a plurality of original feature maps by performing feature extraction on a plurality of original images other than the reference image in the plurality of original images respectively;
acquiring a second fused feature map corresponding to each original feature map by fusing the reference feature map respectively with the plurality of original feature maps through the first fusion subnetwork; and
fusing a plurality of second fused feature maps through the second fusion subnetwork to acquire the first fused feature map.

3. The method for acquiring images according to claim 2, wherein said acquiring a second fused feature map corresponding to each original feature map by fusing the reference feature map respectively with the plurality of original feature maps through the first fusion subnetwork comprises:
acquiring a first reference feature map by downsampling the reference feature map;
acquiring a first original feature map by downsampling the original feature map;
acquiring a first attention feature map by merging the first reference feature map and the first original feature map, and inputting the merged feature map into the first attention network; and
upsampling the first attention feature map to acquire the second fused feature map.

4. The method for acquiring images according to claim 1, wherein said acquiring the adjusted feature map based on the first fused feature map and the plurality of original images comprises:
determining one original image of the plurality of original images as a reference image;
acquiring a plurality of original feature maps by performing feature extraction on a plurality of original images other than the reference image in the plurality of original images respectively;
acquiring a second attention feature map by inputting the first fused feature map into a second attention network; and
acquiring a plurality of adjusted feature maps corresponding to the plurality of original feature maps by inputting the second attention feature map into a plurality of spatial feature transform networks respectively, and inputting the plurality of original feature maps into the plurality of spatial feature transform networks respectively,
wherein the spatial feature transform network is configured to determine a spatial parameter matrix based on the original feature map, and spatially transform the second attention feature map by using the spatial parameter matrix, wherein the spatial parameter matrix is acquired by performing convolution processing on the original feature map.

5. The method for acquiring images according to claim 4, wherein said acquiring the high dynamic range image corresponding to the plurality of original images based on the adjusted feature map comprises:
acquiring the plurality of adjusted feature maps corresponding to the plurality of original feature maps;
acquiring a merged feature map by merging the plurality of adjusted feature maps;
acquiring an important feature map by inputting the merged feature map into a third attention network; and
dimensionally reducing the important feature map through at least one convolution layer to acquire the high dynamic range image.

6. The method for acquiring images according to claim 2, wherein said determining one original image of the plurality of original images as the reference image comprises:
sorting the plurality of original images in descending order of exposure; and
selecting an original image with a centered exposure as the reference image.

7. The method for acquiring images according to claim 2, wherein said acquiring the reference feature map by performing feature extraction on the reference image comprises:
inputting the reference image into a densely connected residual network to acquire the reference feature map.

8. The method for acquiring images according to claim 1, wherein before acquiring the plurality of original images by shooting the same scene, the method further comprises:
acquiring training samples from a sample set, wherein the sample set comprises a plurality of training samples, the training samples comprising a plurality of sample images acquired by shooting a same scene and a target sample high dynamic range image corresponding to the plurality of sample images, and exposures of the plurality of sample images are different;
acquiring a first fused feature map by fusing the plurality of sample images through a to-be-trained fusion network, wherein the fusion network comprises a to-be-trained first attention network;
acquiring an adjusted feature map based on the first fused feature map and the plurality of sample images;
acquiring a high dynamic range image corresponding to the plurality of sample images based on the adjusted feature map;
acquiring a comparison difference by comparing the high dynamic range image corresponding to the plurality of sample images with the target sample high dynamic range image;
adjusting, in a case that the comparison difference is greater than a predetermined result, the to-be-trained fusion network based on the comparison difference and performing a step of acquiring the training samples from the sample set; and
determining, in a case that the comparison difference is less than or equal to the predetermined result, the to-be-trained fusion network as the fusion network.

9. The method for acquiring images according to claim 1, wherein a quantity of the plurality of original images is greater than or equal to 3.

10. The method for acquiring images according to claim 7, wherein the densely connected residual network comprises three 3×3 convolution layers and three activation layers.

11. The method for acquiring images according to claim 1, wherein the first attention network comprises four 3×3 convolution layers, one 1×1 convolution layer, one 3×3 strided convolution layer, two 3×3 dilated convolution layers, one 3×3 depthwise convolution layer, and two activation layers.

12. The method for acquiring images according to claim 4, wherein a quantity of the original feature maps is equal to a quantity of the spatial feature transform networks.

13. The method for acquiring images according to claim 12, wherein the quantity of the original feature maps and the quantity of the spatial feature transform networks are both greater than or equal to 2.

14. The method for acquiring images according to claim 5, wherein said acquiring the merged feature map by merging the plurality of adjusted feature maps comprises:
merging the plurality of adjusted feature maps through a connection function to acquire the merged feature map.

15-18. (canceled)

19. A device for acquiring images, comprising a processor and a memory storing the at least one instruction, at least one program, a code set, or an instruction set, wherein the processor, when loading and executing the at least one instruction, the at least one program, the code set, or the instruction set, is caused to perform a method for acquiring images, comprising:
acquiring a plurality of original images by shooting a same scene, wherein exposures of the plurality of original images are different;
acquiring a first fused feature map by fusing the plurality of original images through a fusion network, wherein the fusion network comprises a first attention network;
acquiring an adjusted feature map based on the first fused feature map and the plurality of original images; and
acquiring a high dynamic range image corresponding to the plurality of original images based on the adjusted feature map.

20. A non-transitory computer storage medium storing at least one instruction, at least one program, a code set, or an instruction set, wherein the at least one instruction, the at least one program, the code set, or the instruction set, when loaded and executed by a processor, causes the processor to perform the method for acquiring images as defined in claim 1.

21. The device for acquiring images according to claim 19, wherein the fusion network comprises a first fusion subnetwork and a second fusion subnetwork, each of the first fusion subnetwork and the second fusion subnetwork comprising the first attention network; and
the processor, when loading and executing the at least one instruction, the at least one program, the code set, or the instruction set, is caused to perform:
determining one original image of the plurality of original images as a reference image;
acquiring a reference feature map by performing feature extraction on the reference image;
acquiring a plurality of original feature maps by performing feature extraction on a plurality of original images other than the reference image in the plurality of original images respectively;
acquiring a second fused feature map corresponding to each original feature map by fusing the reference feature map respectively with the plurality of original feature maps through the first fusion subnetwork; and
fusing a plurality of second fused feature maps through the second fusion subnetwork to acquire the first fused feature map.

22. The device for acquiring images according to claim 21, wherein the processor, when loading and executing the at least one instruction, the at least one program, the code set, or the instruction set, is caused to perform:
acquiring a first reference feature map by downsampling the reference feature map;
acquiring a first original feature map by downsampling the original feature map;
acquiring a first attention feature map by merging the first reference feature map and the first original feature map, and inputting the merged feature map into the first attention network; and
upsampling the first attention feature map to acquire the second fused feature map.

23. The device for acquiring images according to claim 19, wherein the processor, when loading and executing the at least one instruction, the at least one program, the code set, or the instruction set, is caused to perform:
determining one original image of the plurality of original images as a reference image;
acquiring a plurality of original feature maps by performing feature extraction on a plurality of original images other than the reference image in the plurality of original images respectively;
acquiring a second attention feature map by inputting the first fused feature map into a second attention network; and
acquiring a plurality of adjusted feature maps corresponding to the plurality of original feature maps by inputting the second attention feature map into a plurality of spatial feature transform networks respectively, and inputting the plurality of original feature maps into the plurality of spatial feature transform networks respectively,
wherein the spatial feature transform network is configured to determine a spatial parameter matrix based on the original feature map, and spatially transform the second attention feature map by using the spatial parameter matrix, wherein the spatial parameter matrix is acquired by performing convolution processing on the original feature map.

24. The device for acquiring images according to claim 23, wherein the processor, when loading and executing the at least one instruction, the at least one program, the code set, or the instruction set, is caused to perform:
acquiring the plurality of adjusted feature maps corresponding to the plurality of original feature maps;
acquiring a merged feature map by merging the plurality of adjusted feature maps;
acquiring an important feature map by inputting the merged feature map into a third attention network; and
dimensionally reducing the important feature map through at least one convolution layer to acquire the high dynamic range image.
